(19) United States
(12) Patent Application Publication
(10) Pub. No.: US 2011/0244081 A1
(43) Pub. Date: Oct. 6, 2011

(54) Chocolate Containing Vitamin C and Having a Low Glycemic Load

(76) Inventors: Stephen R. Treccase, Saugerties, NY (US); Lisa Protter, Saugerties, NY (US); Dennis Teets, Grantville, PA (US)

(21) Appl. No.: 13/075,311

(22) Filed: Mar. 30, 2011

Related U.S. Application Data
(60) Provisional application No. 61/318,972, filed on Mar. 30, 2010.

(51) Int. Cl. A23G 1/32; A23G 1/40; A23G 1/38; A23G 1/46

(52) U.S. Cl. 426/72; 426/631

(57) ABSTRACT

A line of chocolate confectionery products that contains naturally occurring Vitamin C at a minimum percentage of 2% of the RDADV recommendation and 4% RDADV of fiber. The formulations contain at least 4% of the RDADV of at least 3 of the following vitamin and minerals: Potassium, Vitamin A, Vitamin C, Calcium, Iron, Vitamin K, Phosphorus, Magnesium, Zinc, and Manganese. All of these RDADVs are met without the addition of supplements. The formulations contain between 10% and 60% coconut palm sugar in order to meet the defined nutrition requirements. In order to overcome agglomeration issues the formulations contain at least 2.5% fiber.

### CROSS REFERENCE TO RELATED APPLICATIONS

This application claims priority from U.S. Provisional Patent Application Ser. No. 61/318,972, entitled “Palm Sugar Chocolate”, filed on 30 Mar. 2010. The benefit under 35 USC §119(e) of the United States provisional application is hereby claimed, and the aforementioned application is hereby incorporated herein by reference.

### FEDERALLY SPONSORED RESEARCH

Not Applicable

### SEQUENCE LISTING OR PROGRAM

Not Applicable

### TECHNICAL FIELD OF THE INVENTION

The present invention relates generally to a food product. More specifically, the present invention relates to a process for creating chocolate containing vitamin C and having a low glycemic load and a plurality of formulations or products that can be made by the process.

### BACKGROUND OF THE INVENTION

Chocolate bars have been around since the 1800's and are one of world's most delicious foods due to the combination of fat, sugar, and cocoa or dairy solids. It can be found in a wide variety of formats but each of these formats is covered by one of three categories: dark chocolate, milk chocolate, and most recently white chocolate. Legal Standards of Identity regulating the fat, sugar, and cocoa percentage in these three categories vary depending on an individual country's regulations; however, the general ingredients do not.

Dark chocolate is composed of only the components of the cacao bean (cocoa butter and cocoa solids) and a nutritive carbohydrate sweetener in the form of either cane or beet sugar. In addition to the cacao and sweetener components, a vanilla component is frequently included to round out the flavor profile. Also, soy lecithin (a known allergen) is frequently used as a processing aid to thin the product. Milk chocolate adds a dairy component that softens the texture and mellows the bitter notes of dark chocolates while adding butter notes. Traditionally chocolate had three basic dairy components: whole milk or milk powder, nonfat milk solids, and milk fat. Today there are many variations on these components as each one may be broken down into their more basic components to reduce ingredient cost. Two of these components are lactose, and caseinate. White chocolate is composed of cocoa butter, sugar, and a combination of the dairy ingredients mentioned above.

Both cacao fat and cacao solids are considered to have many nutrition benefits including being high in antioxidants, rich in B1, B2, and D vitamins, a good source of iron and the highest level of magnesium available in nature. Magnesium has long been considered to be deficient in the American diet due to its degradation in cooked foods and roasted chocolate, yet, is specifically required for optimum heart function and health which explains why there is so much heart disease in a ‘land of plenty’. In addition, cacao components have been associated with the ability to decrease blood pressure, lower LDL cholesterol, reduce depression and cause euphoria due to the release of serotonin and phenolethylalamine. Cacao products have long been recognized by the healthy, organic, and traditional chocolate lover as a relatively untapped source with the potential to deliver superior health benefits.

Refined cane and beet sugar are another story in that they are used primarily to add sweetness to make a chocolate palatable and to give chocolate its unique physical structure and snap, but are very low in nutrients and moderately high in calories. See chart for nutrition comparison of coconut palm sugar to refined white sugar.

The Philippine Food and Nutrition Research Institute released the information about their analysis of nutritive values found in coconut palm sugar as shown in Table 1.

TABLE 1
Comparison of the Elemental Content of Three Sources of Edible Sugar

| | | | | | | Re- |
|---|---|---|---|---|---|---|
| Macro- | Coconut | | | | | fined, |
| nutrients | Palm | Agave | | Maple | Brown | White |
| (mg/100 gm) | Sugar | Syrup | Honey | Syrup | Sugar | Sugar |
| Nitrogen (N) | 202 | NA | NA | NA | 10 | 0 |
| Phosphorus | 79 | 7 | 4 | 2 | 3 | 0 |
| (P) | | | | | | |
| Potassium | 1,030 | 1 | 52 | 234 | 65 | 2.5 |
| (K) | | | | | | |
| Calcium | 8 | 1.5 | 6 | 67 | 24 | 6 |
| (Ca) | | | | | | |
| Magnesium | 29 | 1 | 2 | 14 | 7 | 1 |
| (Mg) | | | | | | |
| Sodium (Na) | 45 | 1 | 4 | 9 | 2 | 1 |
| Chloride (Cl) | 470 | NA | NA | NA | 16 | 10 |
| Sulfur (S) | 26 | NA | NA | NA | 13 | 2 |
| Boron (B) | 0.6 | NA | NA | NA | 0 | |
| Zinc (Zn) | 2 | 0.2 | 0.2 | 4.2 | .2 | 0.1 |
| Manganese | 0.1 | 0.1 | 0.1 | 3.3 | .2 | 0 |
| (Mn) | | | | | | |
| Iron (Fe) | 2 | 1 | 0.4 | 1.2 | 1.26 | 0.1 |
| Copper (Cu) | 0.23 | 0.1 | 0 | 0.1 | 0 | 0 |
| Thiamine | 0.41 | 0 | 0 | 0 | 0 | 0 |
| Vitamin C | 23.4 | 0.5 | 0.5 | 0 | 0 | 0 |

They are considered to be highly processed due to the use of chemicals in their refining process. Refined sugars are also known to exacerbate many diseases associated with poor nutrition and lifestyle choices including diabetes, food addiction/allergies, obesity, hyperactivity, and hypertension. These and other diseases which were considered late in life issues are currently affecting the youth of the country in epidemic proportions like never before. This makes conventional chocolate a poor food choice for many people. In addition, the consumption of even moderate amounts of conventional chocolate products manufactured with cane or beet sugar chocolate delivers a high percentage wallop of Recommended Daily Allowance (RDA) calories, but contributes a fairly small amount of RDA nutrients to a person's diet, therefore conventionally sweetened chocolate products may often be classified as a nutrient void but calorie dense item that should be avoided as much as possible from a health perspective.

Therefore it is an objective of the present invention to create products and formulations for a plurality of flavor varieties which contain as many of the main vitamins found on a nutrition panel in as high as quantity as possible while providing a pure gourmet chocolate culinary experience. Calcium and iron are found in many common chocolate products. Vitamin A is found in some chocolates containing other inclusions, and the only vitamin not found in any chocolate product at a minimum RDA of 2% or greater was Vitamin C.

There are other nutritional sweeteners which can be used to produce chocolate with a low glycemic index across a variety of cacao percentages however none met the entire requirement of reacting as a traditional sugar in providing texture and not causing other negative physiological issues. The sweeteners evaluated include agave syrups, crystalline fructose, and sugar alcohols. Agave syrup contains a moisture content of approximately 25% and has a low glycemic index, but is hard to incorporate into cocoa butter and other compound fat based systems due to the issue of trying to mix fat based ingredients with a water based ingredient and in general give a softer, lower melt point product, that cannot be melted and tempered or produced on traditional particle reduction equipment. An alternative to using high moisture agave syrup is to evaporate the syrup to a specific moisture content as taught by Brown in US Patent Publication 2008/0248176 for details. However, this requires extra steps of evaporating moisture and is limited in use due to the patent. Sugar alcohols are frequently used in chocolates but have a cooling affect that distracts from the traditional flavor profiles. They also can have a laxative effect or cause other intestinal issues. Crystalline fructose is very expensive and can cause intestinal distress at consumed amounts as low as 25 to 30 grams per day. This material will also cause a sandy texture when conched at temperatures above 104 F.

These negative characteristics of currently available sugars has made the enjoyment of chocolate a negative for many people who are diabetic, simply trying to keep their non-nutritive calorie intake to a minimum, or prefer all natural and or organic ingredients. Other then the negative characteristics mentioned above, the major problem was none of these traditional components contained any Vitamin C.

### SUMMARY OF THE INVENTION

Chocolate has long been delegated to an ‘eat minimally’ food status due to its high calorie content and low nutrition content. In addition, refined cane and beet sugar crystals, the conventional carbohydrates found in chocolate are nutrition void and may actually exacerbate certain disease conditions.

The present invention overcomes these problems by switching to a nutritive carbohydrate that has a low glycemic value and is rich in vitamins and minerals. However, this sugar has not been utilized before by the chocolate industry due to its high moisture and invert sugar content that causes tableting and agglomeration issues using traditional formulations, and refining and conching processes. The present invention overcomes these obstacles through formulating to a minimum of 2.5% fiber, using a shearing or combination shearing and compression mechanism, rather than a compression refining mechanism, slowing adding the sugar to the refiner, and ensuring sufficient agitation is in place to keep the sugar particles suspended until they are sufficiently dispersed in the fiber.

The product of the process of the present invention is a line of chocolate confectionery products that contains naturally occurring Vitamin C at a minimum percentage of 2% of the RDADV recommendation and 4% RDADV of fiber. The formulations contain at least 4% of the RDADV of at least 3 of the following vitamin and minerals: Potassium, Vitamin A, Vitamin C, Calcium, Iron, Vitamin K, Phosphorus, Magnesium, Zinc, and Manganese. All of these RDADVs are met without the addition of supplements. The formulations contain between 10% and 60% coconut palm sugar in order to meet the Code of Federal Regulations Standard of Identity for bittersweet, milk, and white chocolates; and predefined nutrition requirements. In order to overcome agglomeration issues the formulations contain at least 2.5% fiber.

### BRIEF DESCRIPTION OF THE DRAWINGS

The accompanying drawings, which are incorporated herein an form a part of the specification, illustrate the present invention and, together with the description, further serve to explain the principles of the invention and to enable a person skilled in the pertinent art to make and use the invention.

FIG. 1 is a flow chart illustrating the refining process of the present invention.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention. Referring to the figures, it is possible to see the various major elements constituting the apparatus of the present invention.

Chocolate has long been delegated to an ‘eat minimally’ food status due to its high calorie content and low nutrition content. In addition, refined cane and beet sugar crystals, the conventional carbohydrates found in chocolate are nutrition void and may actually exacerbate certain disease conditions. The present invention overcomes these problems by switching to a nutritive carbohydrate that has a low glycemic value and is rich in vitamins and minerals. However, this sugar has not been utilized before by the chocolate industry due to its high moisture and invert sugar content which causes tableting and agglomeration issues using traditional formulations, and refining and conching processes. The present invention overcomes these obstacles through formulating to a minimum of 2.5% fiber, using a shearing or combination shearing and compression mechanism, rather than a compression refining mechanism, slowing adding the sugar to the refiner, and ensuring sufficient agitation is in place to keep the sugar particles suspended until they are sufficiently dispersed in the fiber.

The present invention is a line of chocolate confectionery products that contains naturally occurring Vitamin C at a minimum percentage of 2% of the RDADV recommendation and 4% RDADV of fiber. In addition all of the formulations or products contain at least 4% of the RDADV of at least 3 of the following vitamin and minerals: Potassium, Vitamin A, Vitamin C, Calcium, Iron, Vitamin K, Phosphorus, Magnesium, Zinc, and Manganese. All of these RDADVs are met without the addition of supplements.

The formulations contain between 10% and 60% coconut palm sugar in order to obtain mouth feel, meltdown, and flowability of bittersweet, milk, and white chocolates; and other predetermined nutrition requirements. In order to overcome agglomeration issues, all the chocolates contain at least 2.5% fiber. This fiber isolates the individual particles from each other and thus prevents the agglomeration of the particles over time. However, a refining process was also designed around a shearing verses compression mechanism in order to ensure shearing of the sugar particle into a smaller and smaller size while preventing the tableting of the sugar particles. In a best mode embodiment, the process means of the present invention are melangeur and refiner conches. Adding the sugar over time ensures it gets well dispersed in the ingredient mix and is not allowed to settle onto other sugar particles.

The prevention of agglomeration during the refining and conching process requires slowly adding the sugar into the mass over time in order to keep large particles apart until they are coated with portions of fiber and oil that act to separate the particles. The loading time can be shortened by pre-shearing the sugar in a blade-type high shear blender. In addition, the mixture most be kept agitated in order to prevent the sugar particles from settling on each other prior to be isolated by the fiber particles.

The fat system is a combination of all the fats both added and released that contributes to the flowablility of the chocolate mass and thus the dispersion of the sugar to prevent agglomeration. This fat can be added as a standalone ingredient (cocoa butter, anhydrous milk fat) separate from other ingredients, extracted from other ingredients (cocoa nibs, milk powders, nuts, coconuts, seeds) or added in a fashion that combines separate addition and extracted oil addition. All ingredients containing fat are refined before the sugar is added to release the fat so it can function in affecting the dispersion and suspension of the sugar and flowability of the chocolate. The refining process of the present invention ensures sufficient fat is available to properly disperse the sugar particles.

For the purpose of this patent the purpose of the chocolate refining and conching process is the reduction of the cacao portion (cacao nib, cacao powder, or cacao liquor), dairy portion (nonfat milk solids), nutritive carbohydrates sweeteners, plus any other ingredients with a particle size large enough to be detected by the tongue into a homogenous mass with a particle size of their traditional chocolate counterparts. This is accomplished by reducing the particle size of all ingredients in the chocolate to a maximum size of 15 to 30 microns for standalone bar chocolates and less than 40 microns for a finished chocolate product containing inclusions or an enrobed center. Higher particle size distributions may also be prepared depending on the final use of the chocolate.

The primary method used in the industry to refine a chocolate mass is the roll refiner which processes more than 70% percent of all the chocolate manufactured in the world. In this process temperature controlled, cylindrical rolls are placed side by side and forced together by a mechanical mechanism. A gap is formed between each cylinder. Product is loaded into the first gap. The second roll is turning at a slightly faster speed than the first roll and the third roll is turning faster than the second roll. This increase in speed causes a transfer of the material from one roll to another with the particle size getting smaller and smaller as the mass passes through each gap. The particle reduced material is then scraped off the last roll and on to a conveyor for transfer to a conche where the final amount of cocoa butter is added. The shearing action in this process is a compression action that actually causes the sugar particle to fracture and thus reduce in size. The fracture causes a very intense heat for a split second, which aids in flavor development since the surface of the sugar crystal is melted as it is fractured. Thus, a very low moisture, brittle, particle is required to achieve the desired fracture and thus particle size reduction.

The second method of refining is the ball mill. The grinding mechanism in this process is crushing. In this process steel, acrylic or some other heavy round ball is forced to flow on top of itself in a round cylinder fracturing the material occupying the space between the balls. A screen then prevents the balls from flowing out of the cylinder with the rest of the chocolate mass. For the impact of the balls to break down the ingredients the ingredients must be brittle.

The third type of grinding mechanism used to refine a chocolate mass is shearing. The refiner conche is an example of this action. A refiner conche has a rotor and stator setup. Both of these are in a cylinder form with ribs that cause a shearing action as the ribs from the rotor come closer and closer to the ribs of the stator.

The melangeur is an example of a unit that has both a shearing and crushing action. A melangeur has a bowl with a stone base that rotates. Perpendicular to this bottom stone is a set of other stones that turn as a result of the rotating bottom stone. The gap between the rotor and stator stone is settable and also includes the potential of having down word pressure. As the chocolate mass flows through the gap between the moving stones it is both crushed and sheared. The gap is reduced over time giving an ever finer particle size.

Table 2 describes the difference between traditional beet and cane sugars used in chocolate manufacture and coconut palm sugar. The lower amount of sucrose in conjunction with the higher amount of moisture, reduction sugar and invert sugar make the crystalline structure of coconut palm sugar malleable instead of brittle, and thus likely to tablet instead of break in compression grinding mechanisms such as roll refiners and ball mills. In addition the soft invert sugar acts as a glue that causes resting particles to stick together. This sticking can occur at the initial addition of the sugar to the grinding equipment or over time if the particles are not properly suspending in the oil until the fiber has a chance to isolate the particles from each other so they cannot recombine. This affect is increased the higher the moisture content. Coconut palm sugar contains 1.5 to 3.0% verses 10% for cane and beet sugars.

TABLE 2
Physical and Chemical Differences between Traditional
Cane and Beet Sugars and Coconut Palm Sugar

| | Purity | | Reducing Sugars | |
|---|---|---|---|---|
| Type of Sugar | (Surcose) | Moisture | as Invert sugar | Ash |
| Cane or Beet Sugar | 99.80% | 0.10% | 0.05% | 0.02% |
| Coconut Palm Sugar | ≧75% | 1.5 to 3% | ≦10% | 2 to 3% |

That low sucrose, higher moisture, and higher invert sugar containing carbohydrate ingredients are not suitable for preparing chocolate.

The present invention overcomes these three obstacles that occur due to the chemical and physical difference between coconut palm sugar and cane and beet sugars: the shearing of the large particles into smaller particles without tableting, agglomeration of the sugar with itself and other ingredients during its' addition to the refining equipment, and the prevention of agglomeration during the refining and conching process.

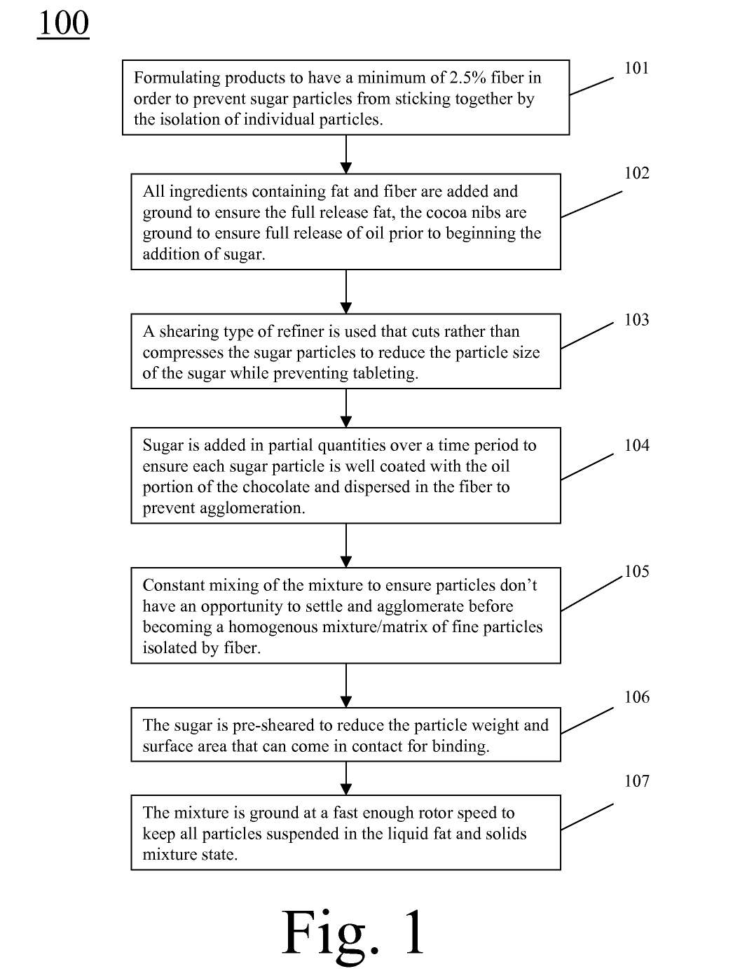

Now referring to FIG. 1, the refining process 100 of the present invention is illustrated. In a first step 101, products must be formulated to have a minimum of 2.5% fiber in order to prevent sugar particles from sticking together by the isolation of individual particles. In the second step all ingredients containing fat and fiber are added and ground to ensure the full release fat, the cocoa nibs are ground to ensure full release of oil prior to beginning the addition of sugar. These ingredients include nuts, seeds, milk components containing fat, and cocoa nibs. In the third step 103, a shearing type of refiner is used that cuts rather than compresses the sugar particles to reduce the particle size of the sugar while preventing tableting. In a forth step 104, the sugar is added in partial quantities over a time period to ensure each sugar particle is well coated with the oil portion of the chocolate and dispersed in the fiber to prevent agglomeration. This is the same sugar addition as in step three. Sugar is always added after all other fat containing ingredients so the fat is available to suspend the sugar. The only exceptions are flavors that are added in such small amounts that that don't have a major affect on the overall fat percentage of the formula. The fifth step 105 includes the constant mixing of the mixture to ensure particles don't have an opportunity to settle and agglomerate before becoming a homogenous mixture/matrix of fine particles isolated by fiber. In a sixth step 106 the sugar is pre-sheared to reduce the particle weight and surface area that can come in contact for binding. In the seventh step 107 the mixture is ground at a fast enough rotor speed to keep all particles suspended in the liquid fat and solids mixture state.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A method of making a chocolate confectionery, comprising:
providing a nutritive carbohydrate coconut palm sugar containing between 1.0 and 4.0 percent moisture, between 1-4 percent ash content, and greater than 75 percent but less 95 percent sucrose content, <12% reducing sugars as invert sugar; and
mixing the nutritive carbohydrate coconut palm sugar into a fiber and a fat to obtain a final formulation that contains at least 2.5 percent fiber and a minimum of 30 percent fat; and
shearing or grinding the mixture until the largest particle size of all the ingredients is less than 60 microns and greater than 15 microns.

2. The method of claim 1 wherein each formulation contains a minimum of 2.5% by weight of fiber to prevent the agglomeration of the nutritive carbohydrate coconut palm sugar particles with either themselves or the other ingredients.

3. The method of claim 3 wherein the fiber is selected from one of the fibers found in cocoa solids, nuts, seeds, flours made from nuts and seeds, grains, legumes, fiberous roots, non-starchy vegetables, and chicory.

4. The method of claim 1 further comprising the step of:
grinding the fiber containing ingredients intimately with fat ingredients to a point where a homogenous, finely ground, smooth on the tongue paste is obtained prior to adding the nutritive carbohydrate coconut palm sugar.

5. The method of claim 1 further comprising the step of:
trickling the nutritive carbohydrate coconut palm sugar into finely ground fat and fiber containing paste over a period of time.

6. The method of claim 6 further comprising the step of:
reducing the particle size of the nutritive carbohydrate ingredient when it has a large amount of particles over 500 microns through a blade blender to a particle size of 400 microns or less in order to prevent agglomeration of the larger particles.

7. The method of claim 1 further comprising the steps of:
adjusting the speed of the agitation to keep all ingredients in suspension; and
agitating until all of the fiber has been release from the fiber containing ingredients.

8. A chocolate product comprising
15 to 85% by weight nutritive carbohydrate;
30 to 50% by weight fat;
less than 1.5% emulsifiers;
at least of 1.2 mg of Vitamin C; and
at least of 0.5 grams of fiber content per 40 grams of serving of a product.

9. The product of claim 8 containing,
less than 15% by weight of the coconut palm sugar; and
more than 3% by weight milk fat, 12% by weight milk solids, or 15% by weight of chocolate liquor.

10. The product of claim 9 wherein a vegetable derived oil, fat, or stearins is substituted for part or all of the cocoa butter.

11. The product of claim 8 containing,
less than 15% by weight of the coconut palm sugar;
more than 3% by weight milk fat, 12% by weight milk solids, or 35% by weight of chocolate liquor.

12. The product of claim 11 wherein a vegetable derived oil, fat, or stearins is substituted for part or all of the cocoa butter.

13. The product of claim 8 containing,
less than 15% by weight of the coconut palm sugar;
more than 3.5% by weight milk fat, or 14% by weight total milk solids, or 20% by weight of cacao fat; and not more than 55 percent by weight nutritive carbohydrate; and
not more than 1.5% by weight total emulsifier.

14. The product of claim 13 wherein a vegetable derived oil, fat, or stearins is substituted for part or all of the cocoa butter.

15. The product of claim 8 containing,
less than 15% by weight of the coconut palm sugar;
more than 3.39% by weight milk fat, 12% by weight total milk solids, or 20% by weight of cacao fat;
not more than 55 percent by weight nutritive carbohydrate; and
not more than 1.0% by weight total emulsifier.

16. The product of claim 15 wherein a vegetable derived oil, fat, or stearins is substituted for part or all of the cocoa butter.

17. The product of claim 8 containing,
less than 15% by weight of the coconut palm sugar;
more than 3.39% by weight milk fat, 12% by weight of sweet cream buttermilk solids, total milk solids, or 20% by weight of cacao fat;
not more than 55 percent by weight nutritive carbohydrate; and
not more than 1.0% by weight total emulsifier.

18. The product of claim 17 wherein a vegetable derived oil, fat, or stearins is substituted for part or all of the cocoa butter.

19. The product of claim 8 containing,
less than 15% by weight of the coconut palm sugar;
more than 3.39% by weight milk fat or 12% by weight of skim milk solids; and
not more than 1.0% by weight total emulsifier.

20. The product of claim 19 wherein a vegetable derived oil, fat, or stearins is substituted for part or all of the cocoa butter.

21. The product of claim 8 containing,
less than 15% by weight of the coconut palm sugar; and
more than 3.39% by weight milk fat.

22. The product of claim 21 wherein a vegetable derived oil, fat, or stearins is substituted for part or all of the cocoa butter.

23. The product of claim 8 containing at least 6.8% by weight nonfat cacao solids.

24. The product of claim 8 containing at least 5% nuts or more than 33% by weight of nuts selected from either Brazil, Cashew, Almond, Hazelnuts, Macadamias, Pecans, Pine nuts, or peanut.

25. The product of claim 24 wherein a vegetable derived oil, fat, or stearins is substituted for part or all of the cocoa butter.

26. The product of claim 8 containing at least 5% fruit powders or more than 25% by weight of fruit powders.

27. The product of claim 26 wherein a vegetable derived oil, fat, or stearins is substituted for part or all of the cocoa butter.

28. The product of claim 8 containing at least 5% fiber or more than 33% by weight of fiber.

29. The product of claim 28 wherein a vegetable derived oil, fat, or stearins is substituted for part or all of the cocoa butter.
